(19) United States
(12) Patent Application Publication
(10) Pub. No.: US 2019/0037866 A1
(43) Pub. Date: Feb. 7, 2019

(54) METHOD AND APPARATUS FOR SUPPLYING FISH PRODUCT

(71) Applicant: ARCTIC IP INVESTMENT AB, Salo (FI)

(72) Inventors: Jari RUUTTU, Salo (FI); Petteri KINNUNEN, Salo (FI)

(73) Assignee: ARCTIC IP INVESTMENT AB, Salo (FI)

(21) Appl. No.: 16/075,356

(22) PCT Filed: Feb. 3, 2017
(86) PCT No.: PCT/FI2017/050061

§ 371 Date: Aug. 3, 2018

(30) Foreign Application Priority Data
Feb. 5, 2016 (FI) 20160027

(51) Int. Cl. A22C 25/18; A23B 4/023; B26D 1/10; B26D 3/28; B26D 7/27

(52) U.S. Cl. CPC A22C 25/18; A23B 4/023; A47F 10/02; B26D 3/28; B26D 7/27; B26D 1/10

(57) ABSTRACT

An arrangement and method for slicing a fish fillet. The arrangement comprises a slicing space which is isolated from its surroundings and unmanned, receiving means for receiving a cutting platform comprising a fish fillet (10) into the cutting space, said cutting platform being fillet specific so that it is arranged to be replaced with the fish fillet (10) adapted on it, a cutting blade (9), which is non-rotating and adapted in the slicing space, a cutting actuator adapted to bring the cutting blade (9) into a linear cutting movement in relation to the cutting platform to detach a slice from the fish fillet (10), and transfer means arranged to transfer the blade to such a position in relation to the cutting platform where the subsequent slice is cut off from the fish fillet (10).

### BACKGROUND

The invention relates to an arrangement for slicing a fish fillet.

The invention further relates to a method for slicing a fish fillet, in which the fish fillet is sliced in a machine that comprises a slicing space.

A cold-processed fish product, such as gravlax, carpaccio salmon, cold smoked salmon and similar fish product are most difficult to slice, for which reason slicing has typically been carried out at a fish processing plant far away from the actual place of sale. The reason is the difficult slicability of the fish product, for which reason fish products cannot have been sliced at a shop because a working slicing device has not existed.

### BRIEF DESCRIPTION

The arrangement and method according to the invention are characterised by what is disclosed in the characterising parts of the independent claims. The other embodiments of the invention are characterised by what is disclosed in the other claims.

Inventive embodiments are also set forth in the specification and drawings of this application. The inventive content of the application may also be specified in other ways than in the claims below. The inventive content may also consist of a plurality of separate inventions, in particular if the invention is examined in light of the expressed or implicit part tasks or from the viewpoint of the benefits or groups of benefits gained. The aspects of the various embodiments of the invention may, within the basic idea of the invention, be applied in connection with the other embodiments.

The arrangement and method for producing a sliced fish product are based on delivering a whole fish fillet to the customer, who places it in a slicing device that performs the slicing. According to an idea, the fish fillets are delivered as trimmed, processed, and complete without bones and skin. The customer may be a shop, restaurant, catering service, or an end-user's home, for example. The slicing device may be fully automatic, which packs the slices after slicing, semi-automatic, in which a shopkeeper, for example, takes the slices from the machine and packs them for a customer, or customers themselves take the sliced products from the machine. According to an idea, the device is modular and may be placed in various spaces that substantially differ from each other. The method and device make it possible to replace prior art solutions in which pre-sliced fish packed in a vacuum package or protective gas package is delivered to the customer, such as a shop.

The arrangement and method present a solution where packing waste may be eliminated or its amount substantially reduced, the product is far fresher, and the level of hygiene is higher. For this, a new slicing device is required, which may be placed on the premises of a shop/restaurant/customer as an independently operating unit, a desktop unit, or placed in an existing cold space, such as a cold counter.

The arrangement and method may obviate the need to pack finished fish slices in plastic small packages. The customer therefore gets entirely fresh fish slices exactly as many as he wants. The slices may be packed in paper, such as greaseproof/wax/food paper either manually or automatically. The fish, such as cold smoked, gravlax, or carpaccio salmon, is delivered in one piece to the shop, and the slicing is carried out by the shop personnel or even the shop's customer.

The arrangement, that is, the slicing device, may be fully automatic in which case the customer informs the slicing device of the number of slices he wants, and the device places the slices on a packing paper, for example. Alternatively, the equipment may operate in such a manner that the slicing, only, is an automatic operation, and the slices are manually removed from the slicing space by the customer or salesperson.

The slicing device has advantageously a modular structure and the slicing space may advantageously be cooled so that it may be kept cooled at a temperature of below 3° C., for example. The slicing device may be placed in the following ways 1 to 4, for example:

1. The slicing device is placed in its own independent thermally insulated closed space, which is substantially air/gas tight, and in which the system is equipped with a dedicated electrical cold compressor device.

2. The slicing device is placed in its own independent thermally insulated closed space, which is substantially air/gas tight, and in which the system is equipped with a dedicated direct current operated Peltier cooling element.

3. The slicing device is placed in its own independent thermally insulated closed space, which is substantially air/gas tight, and in which the system is equipped with a dedicated Peltier cooling element and/or with a passive cold/ice cassette placed in the slicing space.

4. A slicing device, which in itself is not thermally insulated or gas tight, is placed in an existing protected cold space, such as a sales counter in a shop or restaurant.

It is advantageous for the slicing device itself and, in particular, its slicing space to be as small as possible, for example, a planar and low construction external form. The external form of the slicing device is advantageously flat, that is, low, where the height dimension is smaller than the width which in turn is smaller than the length.

At its smallest, the slicing device may have exterior dimensions of, for example 60 cm×19 cm×21 cm (length×height×width), whereby the volume of the device is 24 litres. Out of this, the volume of the slicing space may be as little as 2 litres.

A closed space is a gas/air tight solution whereas a protected space means that access is prevented to the inner parts of the slicing device, its blade, in particular. There has to be a mechanical prevention method that prevents fingers or other parts of the body from being placed in the slicing device while slicing is being performed.

The walls and other parts of the slicing device are advantageously coated with an anti-bacteriological coating, such as silver, silver ions, or silver nanoparticles. This holds true regardless of whether the slicing space is a closed or just protected solution.

The material of the slicing device walls may be stainless steel, acid-proof steel, ceramically coated steel, copper, ceramic, plastic, or glass.

If the slicing chamber is a closed space where the composition of the air/gas may be controlled, the composition of the gas contained in the chamber may be selected from passive protective gasses to reactive gasses, for example.

Examples of passive protective gasses include O₂ and CO₂. Ozone O₃ is an example of a reactive, bactericidal gas. The ozone concentration needs to be adequate to kill bacteria. Because the gas is question is a fresh gas with a very limited lifespan, it has to be fed abundantly and adequately to the space being purified. If the aim is to sterilize the surfaces within the protected space, it therefore requires a great turnover of ozone. In such a case, the volume of the protected sterile space is of major importance. Ozone is classified as a toxic gas and must not be released in too high a concentration to a space where there are people present. Used ozone, still reactive, must be neutralized before it may be let out of the device. Ozone neutralization is performed with an appropriate component designed for ozone neutralization, through which the air fed into the device primarily exits.

In the new method, the slicing device itself is provided with an oscillating one or two blade cutting mechanism in which the cutting pattern is cross cutting at an angle of 90° - 5° in relation to the plane of the fillet, typically between 90° and 45°.

The blade/blades may be made of metal coated with a diamond coating or ceramic, such as aluminium/zirconium oxide and the cutting part of the blade may be toothed or straight. Most advantageously, the cutting edge of the blade is straight because the result it provides is much better (more even and clean-cut) than a toothed blade.

According to an idea, slicing is carried out by an oscillating or double oscillating, linearly cutting method which has one blade tab and in which the radius of curvature of the blade edge sharpening is less than 10 μm, more advantageously less than 1 μm. The sharper the edge sharpening is, the less will the fish meat break and the slicing waste production be.

The fish product itself and the slicing device, or more advantageously only the cutting blade part of the slicing device, is placed in a closed space, other mechanical parts may be placed external to the slicing space.

According to an idea, the fish product is on a platform which is product-specific. In their structure, fish products are elastic, jelly-like, high friction, soft, sticky, and flexible. Due to this, it is advantageous that they need not be moved in relation to their platform: instead, they are immobile in relation to their platform.

In an embodiment, the same platform acts as the cutting platform as the one on which the fish product is stored in the package in which it is brought to the slicing device. The benefit is the saving of packing material and the minimization of the transfer handling of the fish product.

In another embodiment, rolled foil acts as the cutting platform, which places itself in a new position whenever a new fish product is brought on it. The benefit is the cost-effectiveness of the platform.

In an embodiment, the film is fed to the slicing device as a roll, which has a foil for one fish product, only, or the length of the foil corresponds to the length of the platform in the slicing place of the slicing device and receiving the foil in question. Once the foil has fulfilled its task, it is rolled back to said roll either automatically or manually. The benefit is the easy management of the foil.

In a third embodiment, a separate platform acts as the cutting platform, adapted either automatically or manually under a fish product as the need arises, for example, whenever a new fillet is placed in the slicing device. According to an idea, a platform may be entirely removed from the slicing space and replaced, or washed outside of the slicing space. The device operator may himself define the change interval of the platform: whether it is fillet-specific or based on time, for example, such as a replacement once a day. The benefit is the low cost of the solution.

The essential issue for maintaining a high level of hygiene and for not causing contamination between fillets is the replacement of those device parts that are in a physical contact with, for example, the skinless cold processed fish meat set forth. The slicing space itself remains sterile and clean, because a linearly cutting, oscillating straight blade does not create a significant amount of fish residue and its cutting process takes place peacefully whereby fish residue of droplets cannot spread on the walls of the slicing space.

The slower the slicing speed is, the higher will the slicing quality be. Advantageously, slicing takes more time than 2 seconds/slice, more advantageously more than 4 seconds/slice, when the size of the slice is in the neighbourhood of 140 mm×30 mm or more.

Because fish residue or similar organic parts do not end up on the surfaces of the slicing space, the anti-bacteriological coating, such as a silver nanoparticle, may act efficiently. So, such a slicing device does not require washing with water for its level of hygiene to fulfil the requirements of the health authorities and those provided by law.

In the new method, the slicing speed may be as low as 10 fillets per hour, for example, so one fifth of the prior art fish slicing methods. But it is the slowness of the slicing process that is one of the determining factors that enable an excellent and high-quality end result. In such a case, it is possible to apply the single-blade cutting method with a straight blade most advantageously, having a blade tip, that is, edge, of less than 10 microns, for example, 4 nanometres.

A sharpening that sharp makes possible an almost frictionless and residue-free end result. When a blade this sharp is combined with a linear, slowly oscillating movement, the cutting result is excellent and no cutting residue is created. The clean space remains clean without a wet wash for a long time.

It is in such a case advantageous, if the oscillating linearly cutting blade is equipped with a quick release, in other words, may be quickly replaced, if the washing of the blade unit is carried out outside of the device itself or it is replaced with a new clean one.

According to an idea, the slicing device is equipped with a dosing feeder, which, based on weight, gives price information for the product amount that the customer wants. It is in such a case advantageous if at all times the total weight of the fillet and platform is measured, because the result is available straight away. So, when one slice is detached from the fillet, the weight is reduced exactly by this slice, and indicates exactly how much fillet there is left. This way, the operator may be prepared for placing a new fillet in the machine, or the machine may automatically replace a new fish fillet for slicing.

In addition, the weigh may be predicted by means of software so that the device may learn the average slice weights of the fillet at different spots of the fillet. This way it is possible to predict the weight and price of the desired number of slices. To improve the predictability, the size and shape of the fillet may be measured during the process with optical sensors, for example.

The external form of the filled is advantageously trimmed to be within a particular tolerance so that the slices of a skinless fillet are of the same size after slicing. For example so that a standard length, width, and height has been established for a fillet. In such a case, the dimensions of the fillet may be, for example: length 55 cm, width 16 cm, and height 3 cm. When the raw material is, for example, a salmon weighing 5 to 6 kg, the dimension and weight tolerances of the fillet are ±40%, most advantageously no more than ±20% on the area of the whole fillet. In such a case, there would be no need to weigh the slices, for example, but the sales would be based on the number of the slices.

The size, external dimensions, and weight are critical factors with the placing into a store or restaurant interior in mind. According to an idea, the size of the device is less than 600×600 mm by its area, whereby it may be placed in standard-sized fittings or on a desk.

In the slicing space, ice or cold gel cassettes may also be placed either independently of in combination with other cooling technology, such as a Peltier element. The slicing space may be open and part of a shop's cold space, in which case the slicing device is a mere frame into which the mechatronics is fixed, open as regards its structure, and this is placed in the shops cold service counter, for example. Such a cold service counter in a shop represents a protected cold space, so not hermetically sealed.

The blade is easiest to replace with a quick release, whereby it is easy to detach for servicing or cleaning and install a new or cleaned blade.

If slicing takes places from the side of the fillet to the other side of the fillet, the blade length may be less than 100 mm. Such a blade is easy to replace with a new one as often as needed. Alternatively, the slicing device is equipped with a blade washing and sterilizing feature. The slicing space itself need not be washed with liquid washing agents.

According to an idea, a fish product is processed as disclosed below. The benefit is that a fish product may be achieved with a quality higher than the known sliced fish products and the preparing of which is more ecological and which has a production chain producing substantially less plastic packaging waste.

First, the fish has been filleted in a pre-rigor state, for example, within 2 hours of the butchery, and the skin, and most advantageously also the dark meat right below the skin, have been removed from the fillet. Next, the fish fillet has been placed in a substantially sterile approximately 4 to 10% salt solution having the temperature of −1° C. to +8° C., most advantageously approximately 0° C. in which the fillet is left for 4 to 48 hours, most advantageously less than 24 hours.

Due to this low-temperature solution salting, removing bones from the skinless pre-rigor fillet is easy, a controlled autolysis process is established, and the uncontrollable shrinking of the pre-rigor fillet is prevented. The quality of the fish meat changes in accordance with FIG. 6 due to the change in the proteins after death, and the fast salting of the pre-rigour fillet helps slow down the deterioration of the quality.

After the salting at the first phase referred to in the above, the fish fillet is placed in the second phase salting, which is a dry-salting process. At the second phase salting process, spices and salt may be added to the fish fillet.

In the second phase salting, a fish fillet is packed either individually or together with another of a plurality of fish fillets advantageously in a package where the process liquid (the liquid leaving the fish meat in the autolysis, totalling approximately 6 to 12% of the fillet weight) may be led away from the fish fillet so that the exiting liquid may not affect negatively the quality of the fish meat by being in contact with it. In addition, a pressing force may be formed to the package, which substantially affects how firm the fish meat can be made, and that the correct water activity, enabled by the autolysis, is achieved in the fish meat.

The fillet may be delivered in the above package straight to the end user, for example. The fresh salting process, which typically takes 4 to 8 days, may be performed during transport. When the product reaches its destination, it will have been freshly cured with salt, in other words, cured ready in a cold process and the desired amount of liquid has controllably left the fillet.

So, the transport work process has been included in the preparation chain as an active part and not passive like currently. Transport work processes may also be incorporated into the first-phase salting process, that is, solution salting.

The quality of fresh processed salted, non-hot cooked, fish products, such as gravlax, carpaccio salmon or cold smoked salmon quickly deteriorates with time. If the aim is to maintain as high a quality as possible, it is advantageous that the products are delivered to the customer as fast as possible. This matter is facilitated by performing the raw-spicing process, such as dry salting, during transportation.

Another issue of importance is that when a pre-rigor fillet is first placed in solution salting immediately after butchery, its level of freshness remains very high. This means that the autolysis process is controlled and bacteria growth is non-existent. Further, the salt solution treatment makes it possible to remove the bones from the pre-rigor fillet within approximately a day: without the salt solution treatment, an extra wait of 3 to 5 days would be needed before the rigos mortis is entirely gone and removal of the bones would be possible. This way, a product the autolysis of which is controlled may be delivered to a customer.

The level of freshness may be examined by comparing the mutual relationship (%) between inosine monophosphate (IMP), inosine (Ino) and hypoxanthine (Hx) (the so-called NonoCIB technique). The most important indicator is to examine IMP. In an end product processed by the method according to the invention, IMP typically exceeds 50%. This compared to prior art methods, where it is typically less than 10% when the product is received at a shop, packed in a vacuum. So, the customer will get a far fresher and higher quality sliced fish product than enabled by the prior art methods.

### BRIEF DESCRIPTION OF THE DRAWINGS

The invention is described in closer details in the enclosed drawings, in which

FIG. 1 is a partly exploded schematic side view of a slicing device,

FIG. 2 a schematic side view of a platform on which a fish fillet is adapted,

FIG. 3 is a schematic view of the oscillating operation of a blade,

FIG. 4 schematic side view of a platform on which a fish fillet is adapted,

FIG. 5 is a schematic view of the cross-section of certain blades,

FIG. 6 shows chemical changes taking place in fish meat,

FIG. 7 is a schematic view of a blade,

FIG. 9 is a partly exploded schematic side view of a slicing device,

FIG. 10 is a schematic side view of a known slicing device,

FIG. 11 is a schematic side view of a slicing device,

FIG. 12 is a partly exploded schematic view of a slicing device,

FIG. 13 is a partly exploded schematic view of a slicing device,

FIG. 14 is a schematic view of a blade,

FIG. 15 is a schematic view of a blade,

FIG. 16 is a schematic view of a blade,

FIG. 17 is a schematic side view of a platform,

FIG. 18 is a schematic side view of a platform,

FIG. 19 is a partly exploded schematic side view of a slicing device adapted in a shop sales counter,

FIG. 20 is a schematic side view of a slicing device,

In the Figures, the invention is shown in a simplified form for reasons of clarity.

### DETAILED DESCRIPTION

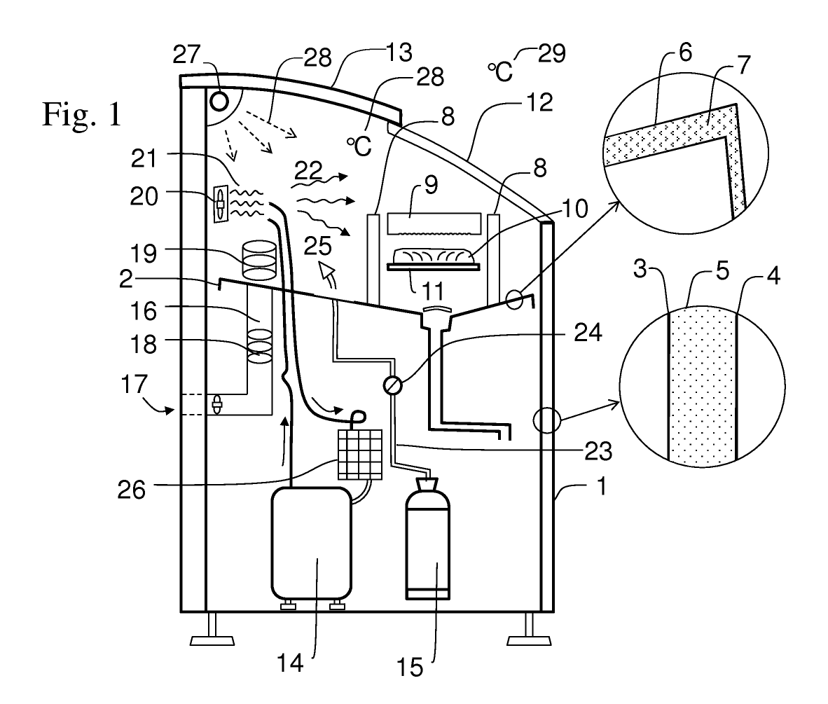

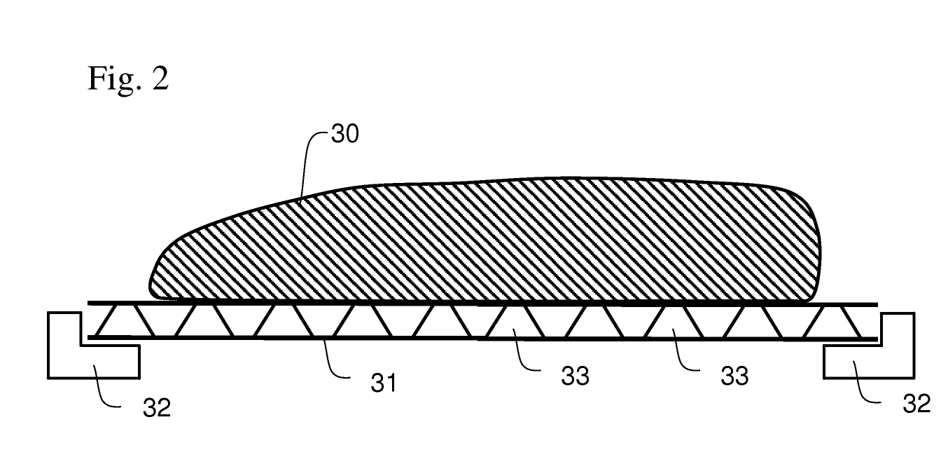

FIG. 1 shows a slicing system located at a shop, at a customer, and its various features which make it independent of external factors, such as temperature and the level of hygiene.

The body part 1 of the machine is divided into two separate parts, a space on top of the intermediate floor 2, where all the parts of the system related to the actual slicing process have been placed and which is a cold/clean space, and a lower space where the parts that are related to something else than the actual physical slicing process. The lower space has installed in it a cold compressor 14, condenser 26, other parts and components of the cold machine, gas bottle 15 which stores the food protective gas, gas supply pipe 23 and an electrically controlled gas valve 24, air input opening 17 and the air cleaning parts such as air filter 18 and HEPA filter 16.

The intermediate level 2 is advantageously also heat insulated and has a food-approved outer surface, such as stainless/acid-proof steel 6, which has on at least one side of it a heat-insulating layer such as polyurethane 7. The upper level is advantageously a fully closed space, and the only connecting channel to the lower space may be, for example, a water discharge pipe that at its end has a fully sealed water/air lock 11.

On the upper level, at least a slicing machine unit 8 has been placed, which has a blade 8 used to slice a fish fillet 11. In addition, it has a compressor 14 and cooling unit 21 in which advantageously a fan unit 20 is also located so that cold air 22 and gas 25 may be efficiently spread all over the upper space.

On the upper level of the device, an air purification unit 19 has also been placed, which purifies the inside air/gas of the upper level very efficiently without the need to feed in new air/gas. This unit may contain special filters such as those for elimination of staphylococcus, legionella, and other bacteria. In addition, with HEPA, plasma, and catalytic filters even E. Coli and harmful gasses can be removed. In addition to all of the above, a UV source 27 may be placed, which produces UV-A and UV-B wavelength light destroying all virus and bacteria stock and which also reacts with oxygen and produces ozone (O₃), which is also an anti-bacteriological gas.

If all the inner surfaces of the upper part are coated with anti-bacteriological coating, such as silver oxide or any bactericidal inorganic or organic coating, it may be shown that the upper part of the device, which is sealed, hermetically sealed, or pressurised, is a most hygienic space.

The device may be a semi-automatic or fully automatic self-service system, and a sliced piece of fish may be output without a person's influence.

FIG. 2 shows a fish fillet 30 placed on a platform 31, which most advantageously is disposable and used when a fish is dry-salted during transportation and storage. For gravlax, in particular, it is advantageous if the fresh-salting process may be started for a pre-rigor quality fillet within 24 hours, for example, advantageously within 12 hours, and most advantageously within 2 hours from the butchery.

When a compression packing method is applied, the empty space 33 forms a low pressure inside the package. In such a case, external air pressure compresses the vacuum package film and therefore the fillet 30 with force. This results in that the fillet 30 does not shrink or uncontrollably change its form, which is typical during rigor mortis. Instead, the package forces the fish fillet to maintain its original shape. The platform is advantageously made of extruded honeycomb plastic such as the plastic made by Wellplast Ab, which includes approximately 50% of calcium carbonate in addition to polypropene. The platform 31 is thus very sturdy for placement directly on the support platform 32 of the slicing device. A new fish fillet is placed on a new platform, so there will be no contamination from a previous fillet when the new fish fillet 30 is placed in the slicing device.

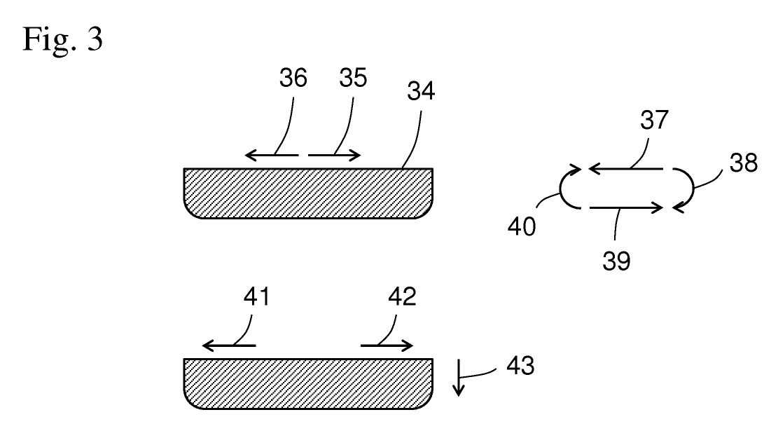

FIG. 3 shows the oscillation feature of a one or two-tab blade 34, where in addition to a back and forth movement 35, 36 is performed in the horizontal direction, with a short trajectory of less than 5 mm, for example, it is at the same time possible to perform a downward movement. In such a case, the blade 34 first moves forward 37, from where it transfers downward 38 making a return movement 39 to ascend back to the starting level 40. This oscillating movement in the lateral and horizontal direction is typically short, less than 5 mm, for example, but it may as little as 1 μm. This is referred to as a micro-oscillating movement in which the oscillating frequency and the amplitude of the movement is a choice due to the blade 34.

The aforementioned micro-oscillation may be combined with the long-path 41 and 41 oscillation of the blade 34, where the trajectory is longer, over 5 mm, for example, while at the same time the blade 34 is carrying out a vertical movement downward towards the product.

The long-path and short-path oscillation is an efficient way to establish a better cutting outcome, which is seen in that no broken fish residue is created and the cutting outcome of the slice is very even. A problem caused by uneven cutting outcome is that a slice of fish, broken on the surface, makes it possible that fish grease leaks out of the slice, and that the fish grease becomes very easily oxidised. Oxidised fish grease is not advantageous for the quality, because it produces a very strong odour and provides a base for bacteria growth. In addition, the fish slice dries up, which in turn affects the physical appearance of the slice in a most negative manner.

A typical thickness these days for a fish slice, as regards, for example, cold smoked salmon or gravlax, is between 1.8 mm and 3 mm. If the surface structure of the slice is damaged, the area on the slice, which becomes oxidised, grows immensely breaking the slice, which further leads to oxidisation multiplying.

The more precise the cutting operation is, the better is the biological quality of the slice, so the greases remain within the meat of the slice and do not flow out, and the oxidisation of the greases is minor.

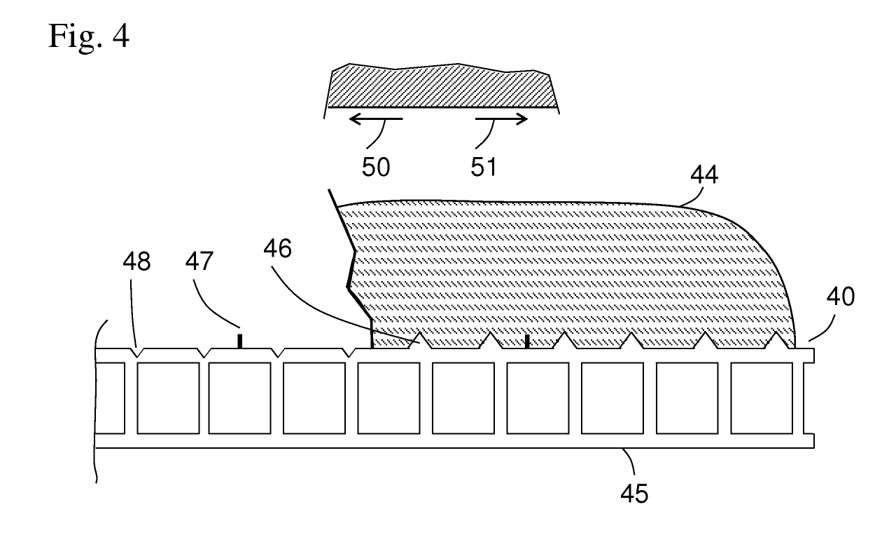

FIG. 4 shows a fish fillet 44 placed on a platform 45, which takes into account the force caused by the back and forth 50 and 51 and the cutting movement of the blade 49 on the fish fillet 44. The lateral force due to the cutting process may also move the fillet 44 in either direction 52, 53 on the platform 45.

This problem is solved by forming a physical obstruction 46, 47 on the platform 44 so that the fish fillet 44 cannot move in the lateral direction.

The feature preventing lateral movement may easily be placed on the side of the injection moulded, deep-drawn, or extruded platform 44 where the fish fillet 44 is located, so that crests 46 or throughs 48 are formed on the platform 48. The crests and troughs may also be micro-sized whereby the same holding effect is created with a small number of bigger grooves or crests or with a larger number of smaller grooves or crests.

If a platform made of paperboard is used, it needs to be formed by compression in such a manner that an adequate number of longitudinal crests 47 or troughs 48 are formed.

To achieve a precise cutting operation, it is advantageous if the fish fillet stays precisely in place, because otherwise the slicing of an elastic, jelly-like substance, such as fish fillet, into slices of 1 mm thick would be very demanding.

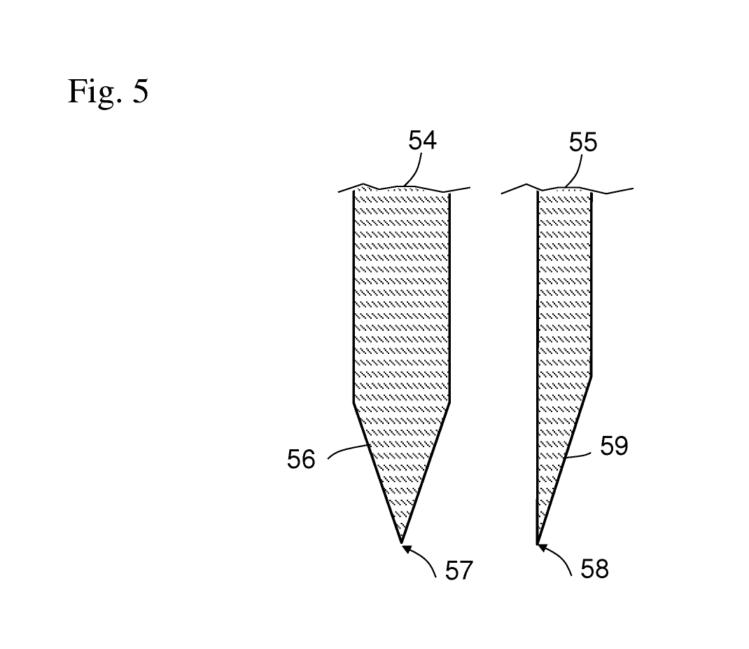

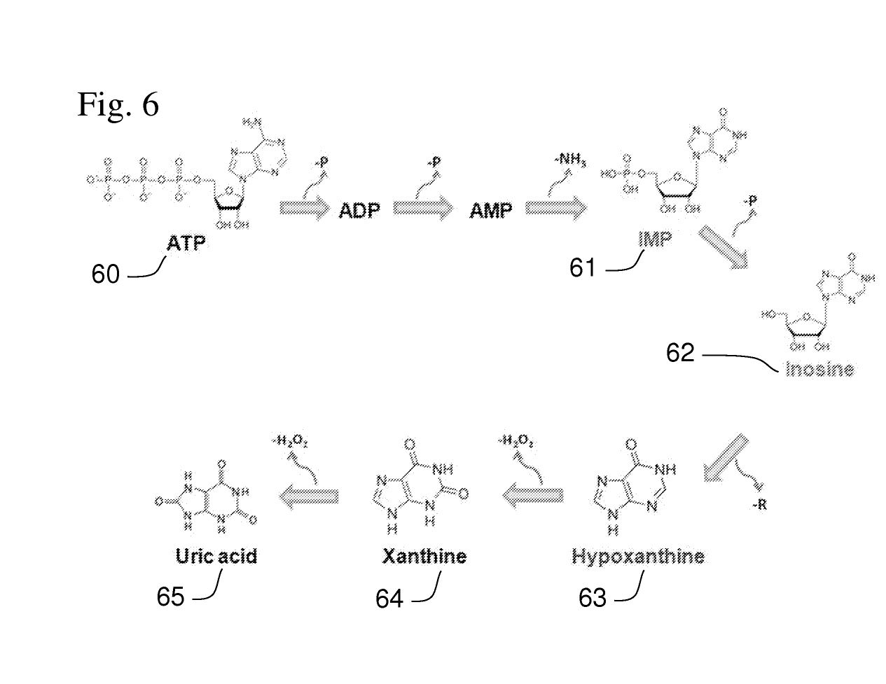

FIG. 5 shows the effect of the evenness and sharpness of the morphological surface of the slicing blade 54, 55 on the outcome, and what frequencies and amplitudes may be applied in the oscillation and cutting movement. The smaller the radius of the cutting edge 57, 58 of the blade 54, 55, the better and more precisely the cutting blade cuts. The typical cutting edge radius of a known two-tab cutting blade in use is larger than 50 μm. This results in that the slice being cut will be damaged on the surface, and at the same time it requires a high cutting power. A high cutting power leads to a fillet not staying in place during a slicing process. This makes the slicing outcome ever worse.

The cutting blade may be sharper, in other words, the radius of curvature of the cutting edge may be smaller than 10 μm and most advantageously less than 1 μm, such as 50 nm or even 4 nm. The material or the cutting blade may be ceramic, such as aluminium oxide, titanium oxide, or metallic and coated with a diamond coating, for example. If the radius of the cutting blade 54, 55 tip 57, 58 is less than 1 μm, the slicing method also works with one blade regardless of the sharpening angle or pattern 56, 59. According to an idea, the morphological surface evenness is achieved with a ceramic, diamond, or organic substance such as fluoropolymers (Teflon, Halar, etc.).

According to an idea, if the blade is “sharper”, that is, the radius of the cutting edge of the blade is less than 10 μm, most advantageously less than 1 μm, and the morphological surface evenness is finer than 20 microns, a one-tab blade may be applied in which the cutting movement is linear and oscillating or double oscillating.

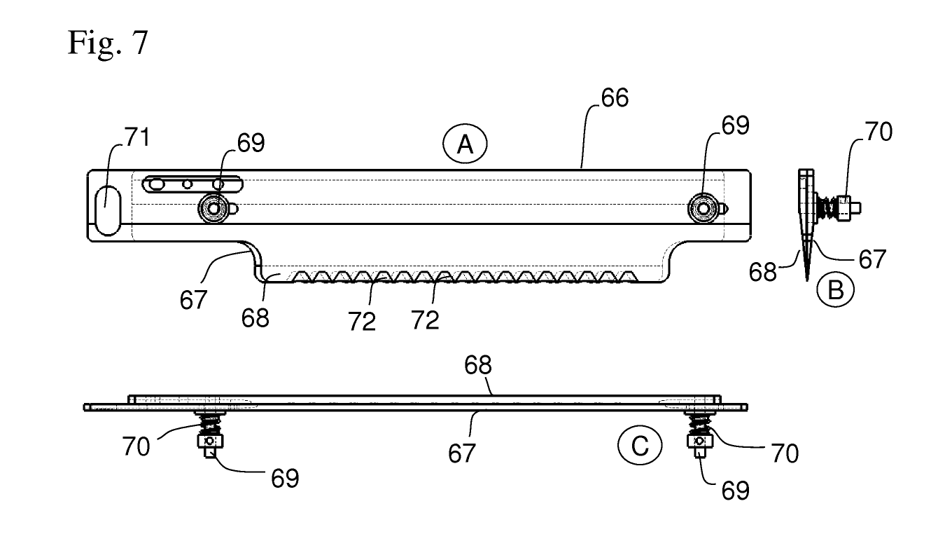

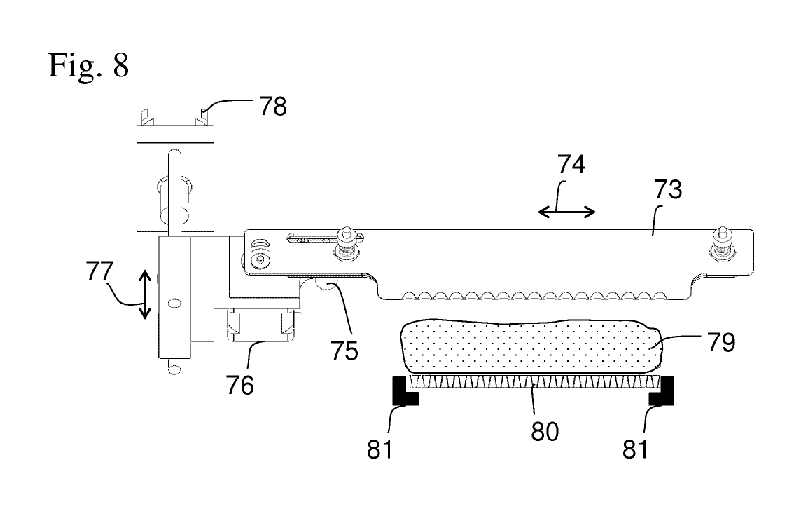

FIG. 7 shows a linearly cutting dual-blade 66, in which two separate blades 67 and 68 have been interconnected so that at least one of the blades 67 or 68 is most advantageously equipped with an oscillating trajectory. The blades are connected together with a spring mechanism 70, placed around the axle 69, for example. In such a case, the tightening mechanisms may be precisely adjusted. The toothing is most advantageously placed on the blade 68 that has the oscillating function. Depending on the structure and material of the blade, the toothing may be 0.1 to 20 mm.

If the blade is ceramic or the cutting part of the blade is diamond coated, the toothing may be from 20 nanometres all the way to 20 microns.

The tightening mechanism of the blades 67 and 68 advantageously also works so that the blades may be separated from each other by at least 1 mm for washing and cleaning.

FIG. 8 shows a solution of how an oscillating 74 one or two-blade 73 cutting mechanism works and in which the blade 73 may be released from the cutting mechanism by a lever 75. The mechanism includes the producer of the oscillating action, such as a piezo element, piezo vibrator, or another electrical motor. A second motor unit 78 takes care of the height movement of the blade 73, that is, the actual crosscutting operation of the fillet 79.

In an application, the entire cutting mechanism in which the blade 73 is fixed may move in the longitudinal direction of the fillet 79 and carry out the slicing without the fillet itself moving anywhere but is instead statically immobile.

The platform under the fillet is one of the most critical objects of the entire equipment, because the platform 80 on which the fillet 79 has been placed, touches the platform 80 disclosed on all or its surface area. In case of a greasy fish, such as gravlax or cold smoked salmon, the cleaning of such a surface after the slicing of every fish fillet is an impossible task, practically speaking. On the other hand, for the management of the contamination risk, it would be most essential to clean this object.

In the solution put forth, the platform 80 is product-specific, so may be replaced whenever a new fillet 79 is placed in the slicing device. The platform 80, on which the fillet 79 is placed, is located on top of supports 81 so that the platform stays in place and is easy to replace. The platform 80 may be made of paper, paperboard, plastic, plastic composite, cornflour or another organic substance. If the material of the platform is not meant to be disposable, it may be ceramic, burned clay, or glass.

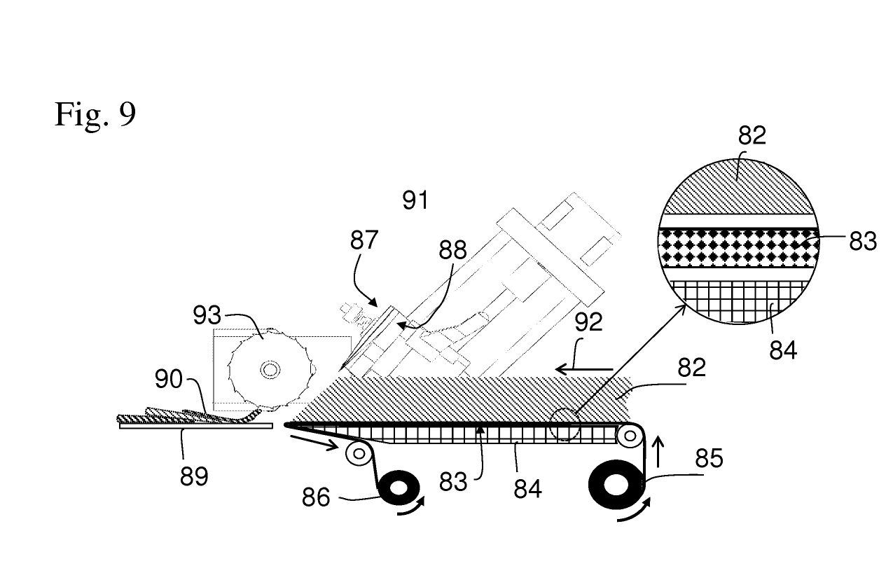

FIG. 9 shows another alternative that meats the same requirements as those in FIGS. 1 and 8. The slicing area is sterile and the space requirement does not change in connection with slicing, and the that the slicing has been done with a linearly cutting blade which is advantageously oscillating, and using a platform which is product-specific.

In the application shown in FIG. 9 the fillet 82 is placed on a band-like platform 83, which is advantageously in a roll form 85 so that whenever a new fillet 82 is placed on a foil-like platform 83, it is wound off onto another roll. This way there is always a new surface on which to place the fillet 82, so the platform material is sterile and there is therefore no contamination risk whatsoever between fillets.

The band-like platform 83 may also transfer the fillet 82 forwards 92 in the direction of the arrow towards the cutting blade 88. The step may be of the length of the slice being cut, such as 2 mm, for example. In this application, the cutting blade 88 and the entire related mechanics are in place and the fillet is moving, but the size of the sterile slicing space does not change because the platform 83 exits onto a roll 86. So, there is no need for a longitudinal space, which would otherwise be a position for a stiff platform, before slicing or after slicing. In prior art slicing methods, which have a “fixed” platform or a “fixed” band, there must always be room to position the fillet before the blade, which leads to the situation where the space requirement of such slicing machines is always at least twice the length of the fillet.

FIG. 9 additionally shows that below a disposable platform, which is band-like 83, a cooling element 84 may have been placed, cooling the fillet 82 through a direct contact. The cooling element 84 is in direct contact with the transport band 83 which in turn is in physical contact with the actual fish fillet 82. A fish slice 90 may drop straight on the platform or a sheet of paper 89, or it may be moved with a rotating 93 slice shifter.

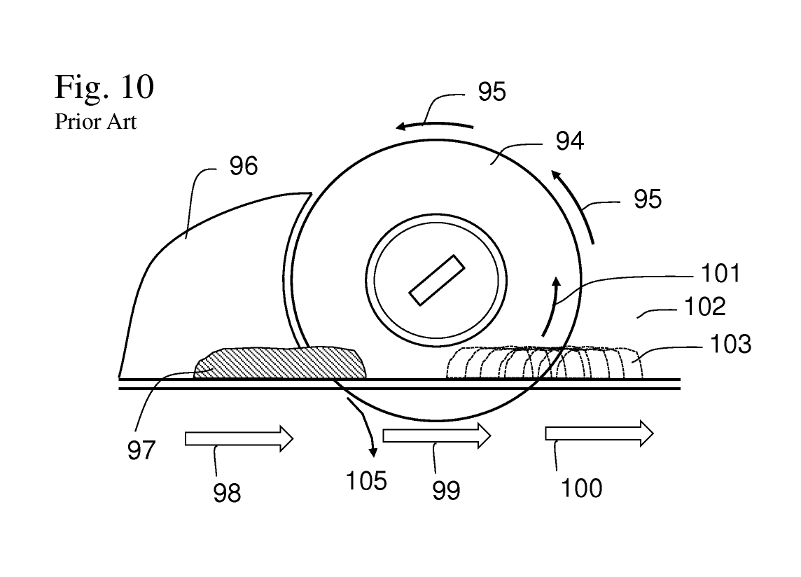

FIG. 10 shows a known slicing device and a method, based on applying a rotating cutting blade 94. The cutting blade typically has the diameter of 180 mm to 400 mm. The blade 94 always rotates 95 so that it presses a product 97 downward 105 from the direction from which the product 97 moves 98 towards the blade 94, and as far 99 and 100 that the product has definitely been cut through, so a slice has been produced.

A problem in applying such a slicing mechanism based on a rotating cutting blade is that first the product 97 is transferred 98, 99, 100 on a linearly moving cradle, on the platform 104, and after that the cradle 104 has to be returned from the end point 108 to the starting point 109, X movement, and transfer the product by the amount 110 of the slice being cut in the direction of the Y movement towards the cutting blade 94. This requires applying the pushing force, which this method is characterised by, on the product 97, because the platform 104 cannot move towards the blade 94 because, after all, it would otherwise be cut through in the same context.

It is known that transferring a glue-like, jelly-like, sticky, high-friction, elastic material such as gravlax and cold smoked salmon on any base is a most difficult work process, if not impossible.

It is additionally problematic that when the product 97 to be cut is jelly-like, elastic and has a high friction on any base material, how could cutting such a material succeed when the application of a rotating blade also needs a background support surface 106 against which the product 97 is pressed before the transfer to the blade 94. The background support surface/board 96 defines the thickness of the slice being cut, and without it cutting cannot be performed at all.

The parts getting dirty are thus the front and back support surface 96, the rotating blade 94 itself, and the back surface 102, the moving cradle/platform and its side support mechanisms, as well as the mechanism transferring the product towards the blade. Slicing carried out with a rotating blade is otherwise problematic, too, because many separate moving parts are required as well as many physical trajectories before one slice has been produced.

It is known that a rotating cutting blade throws particles of meat all over the place, so maintaining cleanness in a sterile space is a very challenging task. Keeping such a prior art device described sterile is a very difficult work process compared to the fact that in the new method only the cutting blade requires daily washing or replacement.

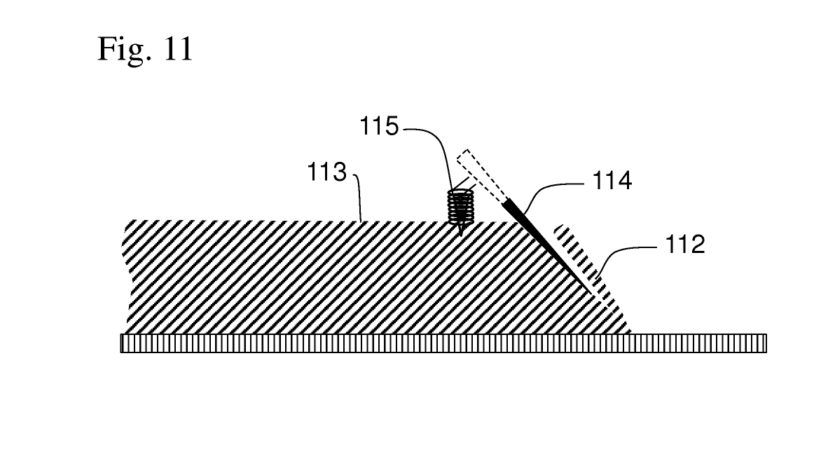

FIG. 11 shows an embodiment in which slicing takes place by an oscillating one-blade linearly cutting slicing device that takes into account the staying in place of the fillet 113 during the slicing process. A dual-blade slicing mechanism works so that typically one blade is oscillating or moves linearly, but the other blade is immobile and in such a case the fillet stays precisely in place.

FIG. 11 shows how the problem has been solved so that, during the slicing process, as the blade 114 cuts the fish meat so that a slice 112 is formed, at the same time a holder 115 has been placed, pressing on the fillet 113 and keeping it in place during the slicing process. The holder 115 need not be big, and it is not subjected to a large force, but it has to be as close as possible to the cutting blade 114. It is advantageous if the holder 115 is a part of the structure of the cutting blade 114 itself. The physical distance will therefore always remain unchanged between the holder 115 and the blade 114 whereby the cutting and slicing result will be constant.

From the viewpoint of the hygiene and cutting outcome, it is advantageous if the blade is ceramic or diamond coated, in which the radius of curvature of the edge of the cutting blade is less than 40 μm, advantageously less than 1 μm, and most advantageously less than 20 nm, for example 4 nm.

A ceramic or diamond coating has two benefits: first of all, a diamond surface is smooth, in other words, is has no pores where bacteria could reproduce, and the surface is slippery, and the sharpness of the blade in which the radius of curvature of the cutting edge may be as small as 4 nm. The sharper the blade is, the lesser is the cutting force and the smoother the cutting outcome. This has a major impact on the preservability of the slice.

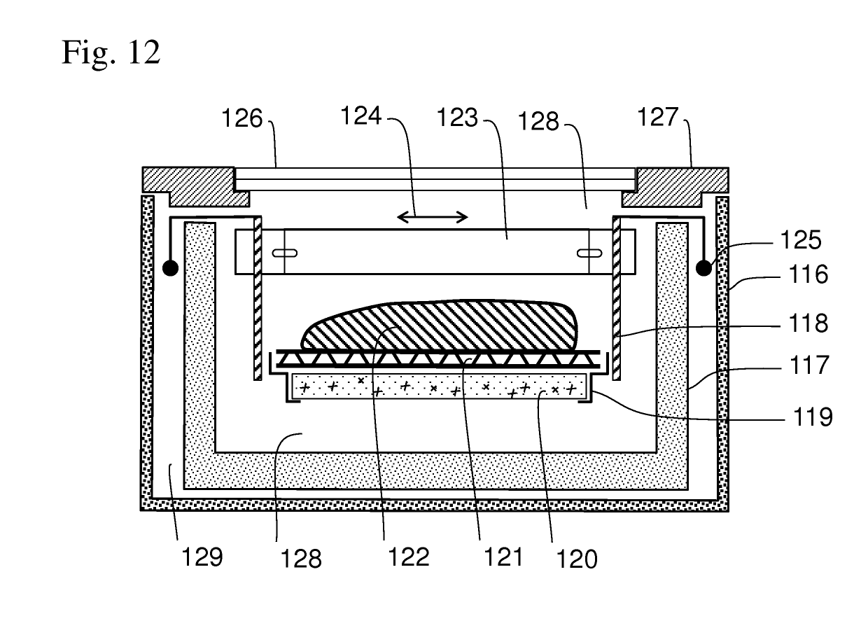

FIG. 12 shows an embodiment of the inventive slicing device, in which the essential issues is the size and the volume of the slicing space 128. This tabletop model fish fillet slicing device is based on the application of the oscillating linearly 124 cutting one or two blade 123 cutting/slicing mechanism advantageously so that the space 128 is isolated and its volume is as small as possible, such as 20 litres. In this case, from the viewpoint of energy-efficiency and hygiene, it is advantageous if all the guides 125, electrical cables, and motors were external 129 to the actual isolated inner tray 117.

In such a case, only the mechanical parts, such as the blade 123 and the components 118 its cutting movement needs, are most advantageously inside the insulated chamber 117. The inner surfaces of the heat-insulating inner chamber 117 are most advantageously coated with a bactericidal coating, such as silver nanoparticles, just like the surfaces of the potentially openable access door 127 and those of the window 126 it potentially has.

It is advantageous if the surfaces of the device, which are touched by the customer or operator are coated on the outside, too, with a bactericidal coating or material, such as the window 126 referred to in the above, and the handles of the access door 127.

The external dimensions of such a small-sized fish fillet slicing device may be, for example 600×300×200 millimetres (length/width/height) and the dimensions of the insulated inner chamber may be 500×200×200 millimetres, so the volume would be 20 litres.

The external dimensions are equally essential as the inner dimensions because such a slicing device is typically meant to be installed on an existing desk/counter, so a device that is too big will not be suitable for the purpose. The space 128 of the inner chamber, where the slicing takes place, is heat-insulated and is advantageously cold, for example, below +4° C. The cold may be produced in such a small 20-litre space in another manner than a cold compressor technology such as the Peltier technology and/or placing an ice cassette/ice/cold gel package 120 in the inner space 128 of the thermally insulated chamber 117. If the cooling power of a Peltier element is inadequate, the introduction of ice or a cold gel cassette, as disclosed, in the same space may be an advantageous solution. An embodiment of the ice cassette 120 may be that it is in direct contact with the platform 121 and consequently cools the fish fillet 122 efficiently.

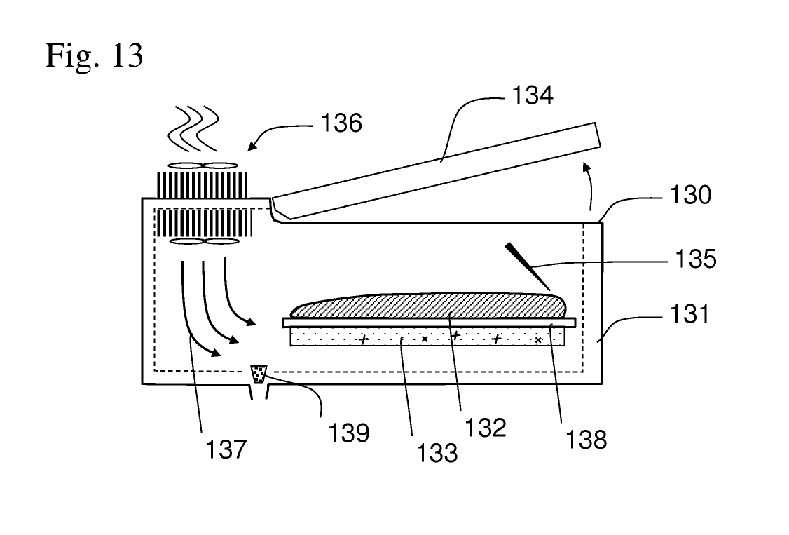

FIG. 13 shows the slicing device according to FIG. 12, in which a fish fillet 132 is placed on its own, product-specific platform 138 and the slicing space 131 is advantageously heat insulated. Cooling may have been carried out with a Peltier cooling element 136 which cools down the air 137 of the slicing space and in which the air mass may be moved with a fan in the most advantageous case. In addition to or simultaneously a cold gel /ice package, or even crushed ice 133, may have been placed in the slicing space 131. If the volume of the ice cassette 133 is, for example, 1.5 litres it may keep the space at 0° C. independently for an entire work day.

Because the external dimension has to be very small, slicing is performed with a linearly cutting oscillating blade 135 so that the fish fillet 132 is always physically in place and the slicing blade 135 is moved back to the extent that new slices may be produced, for example, by 2 mm per slicing. In this method, the platform and the fish fillet are always in place for the whole duration of the slicing process, only the slicing blade 135 and the related mechanism move in the horizontal direction for the thickness of the product slice.

Alternatively, the method according to FIG. 9 may be applied to the device for transferring the fish fillet on a disposable/product specific platform. The platform is formed of flexible material made of food paper, for example, which is in roll form.

The slicing device additionally has a lid 134 which may advantageously be located on top of the slicing device itself, and also has the benefit that cold air always sinks. So, if the lid 134 is opened, this does not remove cold air from the slicing space 131 or allow warm air go in. The difference in principle is the same as between a freezer and an upright freezer; if opened, cold air stays in the freezer, while in an upright freezer cold air “flows” down and is replaced by room-temperature air. This results in substantial loss of energy and causes moisture to condense on the cold inner surfaces. Moisture, from the point of view of hygiene, is not a good thing. It is advantageous to have an opening 139, which may be closed, at the bottom of the insulated slicing space 131 so that condensed or washing water may be led controllably out.

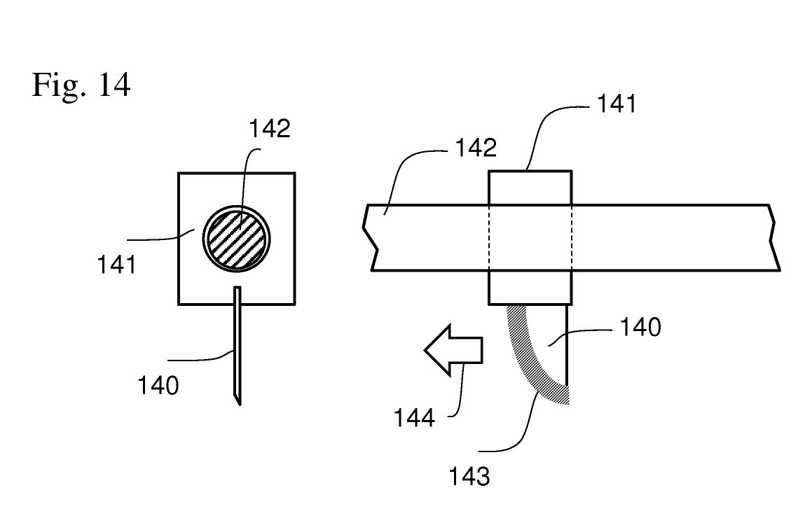

FIG. 14 show a slicing method where the slicing blade 140 is placed on a mount 141 that is movable along a guide 142 so that the sharpened part 143 of the blade cuts the fish meat. The essential new matter is that the blade is very short, for example, only 50 mm high, and that the blade 140 carries out the slicing in the transverse direction of the fillet without being in simultaneous contact with the entire width of the fillet.

In this model, the fish fillet may be stationary and the blade moves also in the longitudinal direction of the fillet, with steps that equal the fillet thickness. Alternatively, the fillet may be movable on a platform, as shown in FIG. 9. In both cases, the fillet is in a static position in relation to the platform, so does not move in relation to the platform.

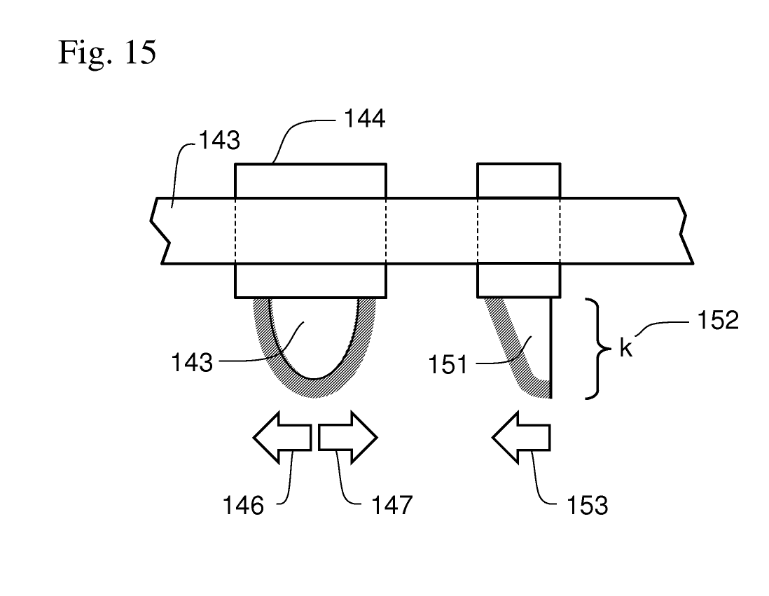

FIG. 15 shows a similar method as FIG. 14, but so that the blade 145 may be sharpened on two sides so that the cutting operation may be carried out in two directions, both in the outward 146 and return 147 direction.

This slicing method makes it possible to place the oscillating movement 150 in the mount 148 and the moving of the blade 151 up and down in the vertical direction 149. This allows the fillet to be sliced in stages by 5 mm, for example, in the depth direction. Typically, a fillet is 30 to 40 mm thick, and if the slicing is carried out at a 90° angle, the height 152 of the slicing blade 151 need not be greater than that of the fillet.

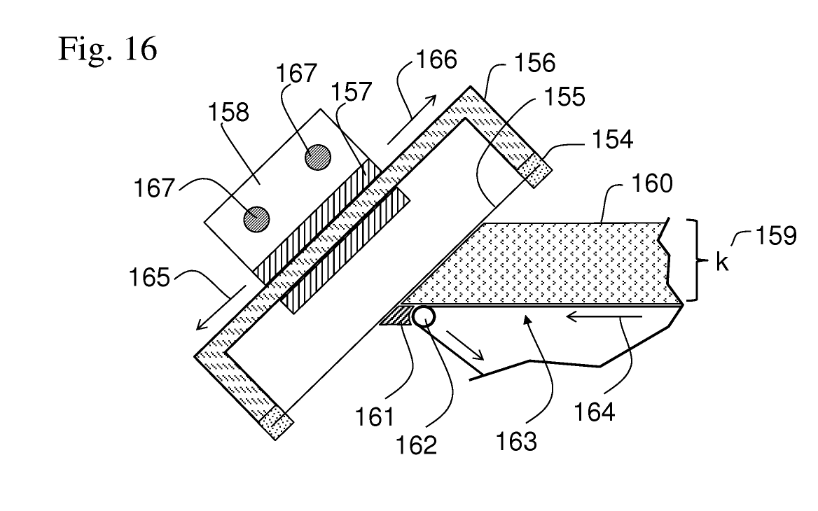

FIG. 16 shows a method very an extremely thin and sharp slicing blade 155 is placed in a support member 156 at both ends 154, the support member 156 is placed in a mount 157 so that the support member 156 may oscillate 165 and 166 freely by 5 mm, for example. The support member 156 oscillates in the vertical direction and is fixed to a mount 158 that allows movement linearly across the entire width of the fillet, such as 200 mm.

The thickness 159 of a fish fillet 160 is typically 30 mm to 45 mm, whereby the length of the blade 155 is less than 100 mm, such as 75 mm when the cutting angle is 45 degrees, for example.

The slicing blade 155 moves under the fillet and since it is known that the fillet 160 is in a static position in relation to the platform 163, the platform is of the film/foil type that turns around a wheel 162 before the slicing blade 155.

The fish fillet 160 is stepped forward 164 by the thickness of the slice, such as 1 mm, and a linear slicing movement is performed, which most advantageously has an oscillating movement 165 and 166. It is advantageous to position a support member at the slicing point 161 so that the slicing blade may go pass it at a very close distance and even contact it. This guarantees that the fillet will not be pressed downward and that the cutting outcome is excellent.

Here, it is possible to use a very thin blade solution in which the blade thickness is less than 1 mm, advantageously even a blade having a thickness of roughly the same as a razor blade, which is typically less than 0.2 mm, and the radius of the blade sharpening may be done so that it is less than 1 μm, advantageously as small as 4 nm.

Such a blade works almost without resistance and does not produce any kind of residue, which typically is created in the dual-blade system where one or both blades are toothed.

The support member 156, in which the blade 154 is fixed at both ends, may oscillate at different frequencies, such as between 1 Hz and 100 kHz, and the trajectory may be ±0.01 mm to 100 mm but is typically ±2 mm to 5 mm.

In such a case, the only parts to replace, in which a product such as a fish fillet has touched, that is, the cutting blade 155 and platform 163, are very easy and cheap to replace with clean ones. Other parts of the clean space are coated with anti-bacteriological coating, such as silver nanoparticles, so will stay sterile.

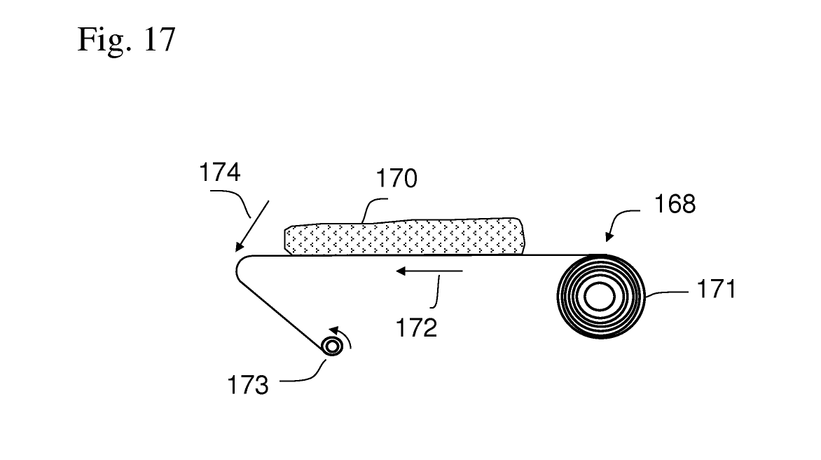

FIG. 17 shows a method of transferring a fish fillet 170 towards a slicing blade 174 by means of flexible material in roll form 171. The material forms a product-specific platform for the fish fillet 170. Such a material may be paper, coated paper, paperboard, other cellulose-based material, plastic-coated paper, plastic foil, such as plastic doped with talcum, biodegradable organic foil, metal foil/film, such as aluminium foil.

So, the platform is always product-specific for the fillet 170, that is, with the principle a new fillet, a new surface. Used film is rolled on a roll 173. The film 168 acting as the platform for the fish fillet is moved forward as much as the slice thickness is desired to be, typically between 0.4 mm and 4 mm.

Foil transfer is performed electrically, just as the slicing process. The foil/film may have been pre-installed in the cassette so that once the film/foil ends, the entire cassette is replaced. A roll may contain 50 m of foil/film, for example, enough for one hundred (100) fillets when their length is 50 cm, or alternatively for one hundred days, if a new platform/surface is introduced per working day.

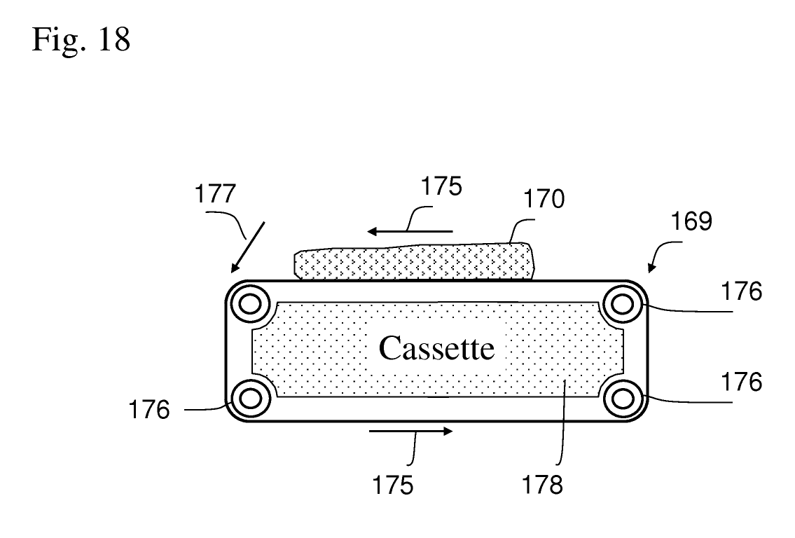

FIG. 18 shows a method of transferring 175 a fish fillet 170 towards a slicing blade 177 so that the transfer film/foil 169 is continuous unbroken, and positioned around at least two 176 wheels or rolls so that the foil/film forms a surface on which the fillet 170 is placed. The length of such a surface is approximately 300 mm to 600 mm or at least the length of the fillet. The transfer film/foil 169 is advanced stepwise according to the desired thickness of the slice, the step length typically being 0.4 mm to 4 mm.

Such a fillet transfer film/foil is more advantageously is made of a viscose material, such as plastic, carbon fibre, metal, other organic material such as cornflour.

According to an idea, anti-bacteriological material such as silver oxide, silver nanoparticles or similar bacteria killing material is included in the actual transfer film/foil material, or placed on its surface.

According to an idea, the equipment comprise sterilization means, used to sterilize the transfer film/foil 169 after a previous fillet has been removed and before the subsequent fillet is placed in the same place on the transfer film/foil 169. The sterilization may be based on, for example, the use of ultraviolet (UV) radiation in which case the sterilization means may comprise, for example, UV LEDs that are momentarily switched on to radiate and sterilize the transfer film/foil 169 on the length of one transfer step at a time, to be switched off after this. The benefit of the UV LEDs and stepwise radiating is a very low power consumption.

If it is desired that the slicing space is cold, a cold cartridge 178 may be placed in such a “cassette” advantageously so that it may cool the fillet 170 directly through the transfer film/foil. Such a cold cartridge may have a volume of 1.5 litres, for example, and is most advantageously placed in the middle of the transfer foil/film so that the transfer foil/film goes around the entire cold cartridge 178.

Such a transfer foil/film cassette is simple to remove and the greases of the previous fillet washed off with hot water, directly with tap water, for example, and put back in the slicing device with a new cold cartridge. The transfer foil/film is still sterile because of the anti-bacteriological feature installed in it, so bacteria cannot be transmitted by this route.

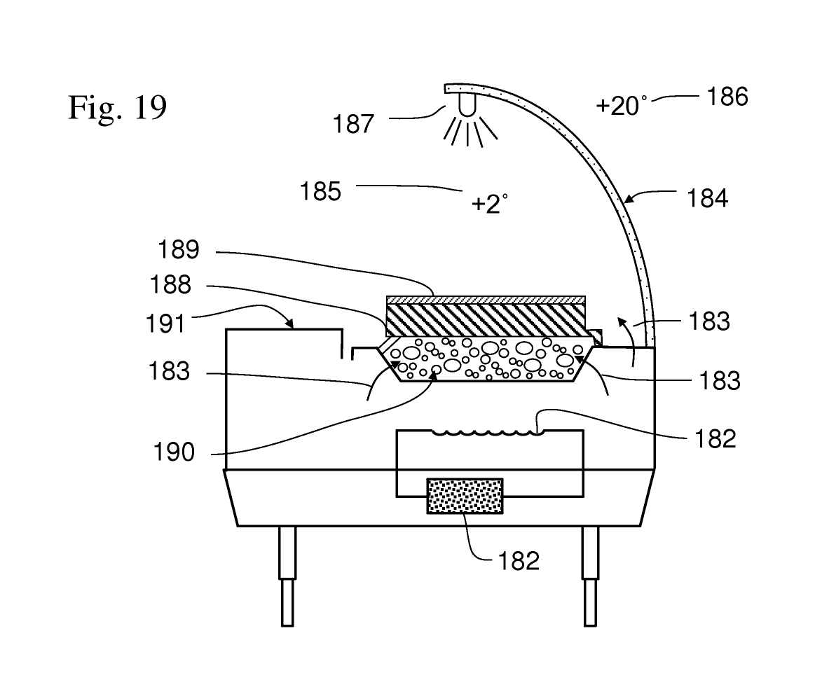

FIG. 19 shows a slicing device 188 placed in connection with a service/self-service sales counter where the temperature 185 has already been lowered to below +4° C. such as +2° C. 185. Such a fish sales counter at a shop therefore has a temperature that the actual slicing device need not be separately cooled. The dedicated cold compressor 181 of the cold counter 179 produces coldness through the condenser 182 so that the cold air stream 183 keeps the surroundings of the cold counter behind a glass 184 cold, at 2° C. 185, for example. In addition, ice 190 is also placed in such sales counters of shops, whereby the temperature may be kept close to 0° C. The slicing device 188 may be provided with a lid 189 so that no accidents happen in connection with slicing. The slicing device 188 may be provided with various kind of adapters, so that it fits in the cold counters of different manufacturers.

Even though the slicing device 188 itself is placed in a space 185 which is cold by definition, it may be advantageous if the slicing space has its own cold unit, such as a cold cassette. A typical cold counter at a shop is not hermetically sealed but protected against biggest unclean air masses and fish is stored in them in other ways, too. This highlights the importance of the shape and size of the slicing device, because a large or heavy device cannot be installed in a cold counter of a shop. The typical available dimensions of a cold space in a shop counter is such that it is 500 mm to 700 mm 192, and there is typically no more than 200 mm available for the height of the slicing device. Another essential fact is that the existing cold counters typically do not have a separate mains outlet to connect the slicing device to. In such a case, the use of a rechargeable slicing device is advantageous. If a low power consumption is desired, it is most advantageous if the slicing operation, only, uses electricity and not the cooling functions. Advantageously the slicing device 188 is so light that it may be removed at the end of a working day when the basin of the cold counter is washed, or the lid 189 is opened and the slicing device is washed together with the remaining cold space 190, 185.

Many shops use ozonized ice because it allows the level of hygiene to be kept very high, and this has been taken into account in the construction of the slicing device so that it may be an open structure or an openable lid which allows access of the sterile ozonized air in the actual slicing space. It is further possible to place ozonized ice directly in the slicing device, or, for example, carbon dioxide ice together, separately or with normal ice. The lid 189 of the slicing device 188 may be transparent and made of glass, for example. The cutting blades of the slicing device are advantageously in a covered place, so that it is not under any circumstances possible to touch them when the lid part 189 of the device is opened or the slicing device is accessed for another reason.

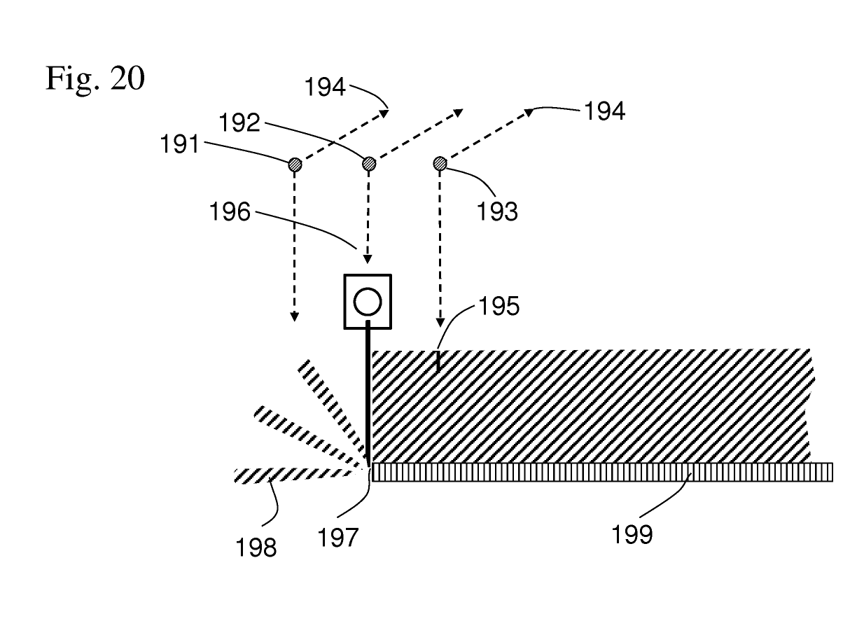

FIG. 20 shows the simplest embodiment of the slicing device, in which the closed space is formed by means of optical detection members 191-193, for example, which prevents a user from being accidentally injured by the slicing blade 197. Such a safety mechanism is known in many industrial sectors. In such a use, the slicing device in all its simplicity is a mere body that has the required mechatronics to carry out the slicing process, the most typical application being, for example, a cold sales/service counter at a shop. This is shown in FIG. 19.

Optical sensors, such as LEDs (light-emitting diodes) 191-193 transmit a light beam 194 in all the required directions, and if the light beam is cut, slicing comes to an immediate end. The slicing blade 197 may is such a case stay in the low position, for example, so that the actual sharp edge cannot be touched. The slicing method of the fish fillet 195 is one of the above configurations, and the slices 198 are always cut from the end of the fillet 195 where the safety mechanism is installed. Typically, the optical safety protection may be implemented with photo-electric guards having the appropriate safety classification, combined with other electric components monitoring safety factors.

The safety mechanism may also comprise a mechanical prevention, or that the blade always goes to the protected space after a cut/slicing, or if the safety mechanism is triggered. The volume of the protected space is the space that remains within the safety mechanism, for example, 2 litres.

In some cases, the features disclosed in this application may be used as such, regardless of the other features. On the other hand, the features disclosed in this application may, if need be, united to form combinations of various kind.

To summarize, the arrangement according to the invention is characterised in that it comprises a slicing space which is isolated from its surroundings and unmanned, receiving means for receiving a cutting platform comprising a fish fillet into the cutting space, said cutting platform being fillet-specific so that it is arranged to be replaced with the fish fillet adapted on it, a cutting blade, which is non-rotating and adapted in the slicing space, a cutting actuator adapted to bring the cutting blade into a linear cutting movement in relation to the cutting platform to detach a slice from the fish fillet, and transfer means arranged to transfer the blade to such a position in relation to the cutting platform where the subsequent slice is cut off from the fish fillet.

If may further be noted that the method according to the invention is characterised by slicing a fish fillet in a device comprising a slicing space which is isolated from its surroundings and unmanned, and in which method; arranging the fish fillet into the slicing space on a cutting platform which is fillet-specific, cutting the fish fillet on the cutting platform with a cutting blade which is non-rotating and adapted in the slicing space, in which cutting the cutting blade is brought into a linear cutting movement in relation to the cutting platform to detach a slice from the fish fillet, transferring the cutting blade to such a position in relation to the cutting platform where the subsequent slice is cut off from the fish fillet, and removing the cutting platform from the slicing space after said fish fillet has been sliced.

The drawings and the related description are only meant to illustrate the idea of the invention. It is obvious for a person skilled in the art that the invention is not restricted to the embodiments described in the above, but many modifications and different application are possible within the scope of the inventive idea defined in the claims below.

1. An arrangement for slicing a fish fillet, which arrangement comprises
a slicing space,
receiving means for receiving a cutting platform comprising a fish fillet into the slicing space,
said cutting platform being fillet-specific so that it is arranged to be replaced with the fish fillet adapted on it,
a cutting blade, which is non-rotating and adapted in the slicing space,
a cutting actuator adapted to bring the cutting blade into a linear cutting movement in relation to the cutting platform to detach a slice from the fish fillet, and
transfer means arranged to transfer the blade to such a position in relation to the cutting platform where the subsequent slice is cut off from the fish fillet,
characterised in that
the slicing space is isolated from its surroundings and heat insulated, and that the slicing space is unmanned.

2. An arrangement as claimed in claim 1, characterised in that the slicing space comprises protective gas means adapted to feed protective gas into the slicing space.

3. An arrangement as claimed in claim 1, characterised in that the arrangement comprises cooling means for cooling the slicing space.

4. An arrangement as claimed in claim 3, characterised in that the cooling means comprise a Peltier element.

5. An arrangement as claimed in claim 1, characterised in that the volume of the slicing space is less than 100 litres.

6. An arrangement as claimed in claim 1, characterised in that the cutting platform is a flexible member, and the receiving means comprise a support structure under the cutting platform, and that
the arrangement comprises feeding means arranged to feed the cutting platform to the receiving means.

7. An arrangement as claimed in claim 1, characterised in that the cutting platform is a substantially rigid platform with which the fish fillet is brought into the slicing space.

8. An arrangement as claimed in claim 7, characterised in that the cutting platform is the same platform on which the fish fillet was dry-salted and stored.

9. An arrangement as claimed in claim 1, characterised in that the cutting blade comprises one and only one cutting blade which is arranged at least substantially parallel to the cutting platform.

10. An arrangement as claimed in claim 1, characterised in that the cutting blade comprises two blades arranged at least substantially parallel to the cutting platform and adapted to be interconnected side by side so that the first blade is movable in relation to the second blade.

11. An arrangement as claimed in claim 1, characterised in that the cutting actuator is arranged to bring the cutting blade exclusively to a linear back and forth movement in the direction of the cutting blade part; in addition, in that the cutting blade is arranged to move, simultaneously with the back and forth movement, towards the cutting platform.

12. An arrangement as claimed in claim 1, characterised the cutting blade in its sideward direction is adapted perpendicular to the cutting platform.

13. An arrangement as claimed in claim 1, characterised in that the cutting blade in its sideward direction is adapted to a smaller angle than 90° but a larger angle than 5° in relation to the cutting platform.

14. An arrangement as claimed in claim 1, characterised the cutting blade is formed by a blade part adapted at least for the most part perpendicular to the cutting platform, and in that
the cutting actuator is arranged to bring the cutting blade into a movement that takes place in the direction of the plane of the cutting platform, and arranged to proceed from the side of one edge of the cutting platform to the side of the opposite edge, and to detach a slice from a fish fillet during the same rectilinear movement.

15. An arrangement as claimed in claim 14, characterised the cutting blade comprises two blade parts adapted at least for the most part perpendicular to the cutting platform, and in that
the cutting actuator is arranged:
to bring the cutting blade into a movement that takes place in the direction of the plane of the cutting platform, and arranged to proceed in a first direction from the side of the first edge of the cutting platform to the side of the opposite edge, and to detach a slice from a fish fillet during the same rectilinear movement,
to transfer the mutual position of the platform and blade for cutting a subsequent slice,
to bring the cutting blade into a movement that takes place in the direction of the plane of the cutting platform, and arranged to proceed in a second direction from the side of the second edge of the cutting platform to the side of the opposite edge, and to detach a slice from a fish fillet during the same rectilinear movement.

16. An arrangement as claimed in claim 1, characterised in that the blade is non-toothed.

17. A method for slicing a fish fillet, in which method a fish fillet is sliced in a device comprising a slicing space which is isolated from its surroundings, heat insulated, and unmanned, the method having the steps of;
arranging the fish fillet into the slicing space on a cutting platform which is fillet-specific,
cutting the fish fillet on the cutting platform with a cutting blade which is non-rotating and adapted in the slicing space, in which cutting
bringing the cutting blade into a linear cutting movement in relation to the cutting platform to detach a slice from the fish fillet,
transferring the cutting blade to such a position in relation to the cutting platform where the subsequent slice is cut off from the fish fillet, and
removing the cutting platform from the slicing space after said fish fillet has been sliced.

18. An arrangement as claimed in claim 1, characterised in that the volume of the slicing space is less than 20 litres.

19. An arrangement as claimed in claim 1, characterised in that the volume of the slicing space is less than 2 litres.

20. An arrangement as claimed in claim 1, characterised in that the cutting blade in its sideward direction is adapted to a smaller angle than 90° but a larger angle than 45° in relation to the cutting platform.
